(19) United States
(12) Patent Application Publication
(10) Pub. No.: US 2021/0181221 A1
(43) Pub. Date: Jun. 17, 2021

(54) ANALYZING SYSTEM, AUTO-SAMPLER, AND AUTO-SAMPLER TEMPLATE SHEET

(71) Applicant: SHIMADZU CORPORATION, Kyoto-shi, Kyoto (JP)

(72) Inventor: Manabu SHIMOMURA, Kyoto-shi, Kyoto (JP)

(73) Assignee: SHIMADZU CORPORATION, Kyoto-shi, Kyoto (JP)

(21) Appl. No.: 16/973,819

(22) PCT Filed: Jul. 11, 2018
(86) PCT No.: PCT/JP2018/026143

§ 371 Date: Dec. 10, 2020

(51) Int. Cl. G01N 35/10; G01N 30/24; G01N 35/04; G01N 30/72

(52) U.S. Cl. CPC G01N 35/1009; G01N 30/24; G01N 2035/0441; G01N 30/7206; G01N 35/04

(57) ABSTRACT

An analyzing system includes: a storage unit that stores batch files, each of which describes a measurement order of samples and a measurement condition for each of the samples and identification information; a sample arranging member which has identification information attached at a predetermined position of the sample arranging member, the identification information being in correspondence with a batch file to be used for measuring the samples; an auto-sampler to which the sample arranging member is set that sequentially collects one or more samples; an identification information reader that reads the identification information on the sample arranging member, and an analysis controller that reads out, from the storage unit, the batch file which corresponds to the identification information read by the identification information reader, and, based on a description in the batch file, controls the auto-sampler and an analyzer so as to measure the one or more samples.

### TECHNICAL FIELD

The present invention relates to an analyzing system that includes an auto-sampler provided with a plurality of sample arrangement units. In the analyzing system, the auto-sampler is configured, in a predetermined sequential order, to collect samples arranged in the plurality of sample arrangement units, introduce the samples into an analyzer, and measure each of the samples under a predetermined measurement condition.

### BACKGROUND ART

In order to quantitate a target component contained in a sample, a gas chromatograph or a liquid chromatograph (hereinafter, collectively referred to as a “chromatograph”) is used. When quantitating the target component using the chromatograph, the target component temporally separated in a column of the chromatograph is measured to obtain chromatogram data, and based on the chromatogram data, an area (or a height) of a peak of the target component is obtained. The area (or height) of the peak of the target component is applied to a calibration line previously prepared, so that concentration of the target component is determined.

When a large number of samples are dealt with in the chromatograph, a chromatograph including an auto-sampler (also referred to as an auto-injector) as a sample introducer is used. The auto-sampler is a device configured, in a predetermined sequential order and timing, to automatically collect samples from a plurality of sample containers (e.g., vials) accommodated in a sample rack and introduce the samples into the chromatograph. By using the auto-sampler, it is possible to automatically and successively measure the large number of samples (see, for example, Patent Literature 1).

When the auto-sampler is used to automatically measure the plurality of samples, an analyst previously does a series of operations, as follows. First, the analyst puts the plurality of samples respectively into the plurality of vials, and arranges each of the plurality of vials at a predetermined position of the sample rack.

Next, the analyst corresponds each of the plurality of samples to a method file, which describes a measurement condition in the chromatograph, and arranges the method files of the plurality of samples in the measurement order of the samples to create a batch file. The batch file is stored in a storage unit of the analyzer. Each of the method files includes, for example, an amount of the corresponding sample introduced into the chromatograph, retention time of the target component in the corresponding sample, and a detection parameter for the target component. As the detection parameter for the target component, for example, a mass-to-charge ratio is used when the chromatograph includes a mass spectrometer as a detector; and a wavelength of irradiation light or detection light is used when the chromatograph includes a spectrophotometer as a detector.

After creating the batch file, the analyst sets the sample rack, where the plurality of vials containing the samples are arranged, in the auto-sampler. After setting the sample rack in the auto-sampler, the analyst reads out the batch file and operates, such as pressing a start button, to command start of the measurement. Then, the samples are collected in the sequential order from the vials set in the auto-sampler, and each of the samples is measured under the measurement condition described in the batch file. As a result of the measurement, the chromatogram data is obtained and sequentially stored in the storage unit of the analyzer.

### CITATION LIST

### Patent Literature

Patent Literature 1: WO 2016/189668 A

### SUMMARY OF INVENTION

### Technical Problem

Various types of samples are measured in a chromatograph. Thus, a large number of batch files that describe various measurement conditions in accordance with the types of the samples are stored in a storage unit of an analyzer. As has been described above, conventionally, an analyst autonomously reads out the batch files at start of the measurement. Here, the analyst may read out a wrong one of the batch files and carry out the measurement based on the wrong one. The wrong batch file describes the measurement condition for other sample than the sample to be measured. The measurement based on the wrong batch file does not result in a correct measurement.

Here, described above is a case where the vials are set in sample accommodating units of the sample rack and the samples contained in the vials are measured. However, this problem is common when samples are arranged in a plurality of sample arrangement units to be measured, such as when samples contained in a plurality of wells on a sample plate are measured. Further, this problem also occurs when the auto-sampler is used to introduce the samples into other types of analyzers than the chromatograph for measurement.

An object of the present invention is to provide a technique to measure each of samples arranged in a plurality of sample arrangement units of an auto-sampler under a correct measurement condition.

### Solution to Problem

In order to solve the problems previously described, a first aspect of the present invention provides an analyzing system including:

a storage unit configured to store a plurality of batch files, each of which describes a measurement order of one or more samples and a measurement condition for each of the one or more samples, and identification information in correspondence to each of the plurality of batch files;

a sample arranging member which is a member including a plurality of sample arrangement units each for arrangement of a sample, and has identification information attached at a predetermined position of the sample arranging member, the identification information being in correspondence to a batch file to be used for measuring one or more samples arranged in some or all of the plurality of sample arrangement units;

an auto-sampler to which the sample arranging member is set, and which is configured to sequentially collect one or more samples arranged in some or all of the plurality of sample arrangement units;

an identification information reader configured to read the identification information in the sample arranging member that has been set to the auto-sampler,

an analysis controller configured to read out, from the storage unit, the batch file that corresponds to the identification information read by the identification information reader, and configured, based on a description in the batch file, to control the auto-sampler and an analyzer to measure the one or more samples.

While, in many cases, a batch file describes measurement conditions for a plurality of samples, the batch file above may describe a measurement condition for only one sample. When the batch file describes only one sample, the measurement order of the sample is not required to be determined. Thus, the batch file only describes the measurement condition for the sample.

As the identification information, for example, characters, symbols, or images may be used. Alternatively, visually identifiable information obtained by combining the characters, symbols, or images with color information may be used. In any case, the identification information reader may be, for example, a combination of an image acquiring unit and an image analysis unit. The image acquiring unit captures an image representing the identification information, and the image analysis unit identifies the image. Alternatively, an IC chip that electronically describes the identification information may be used, and as the identification information reader, an IC chip reader may be used. Here, the IC chip reader reads out the identification information in short-range wireless communication with the IC chip.

In the analyzing system according to the first aspect of the present invention, the batch files, each describing the measurement order and the measurement conditions for the one or more samples to be measured, are previously created, and are stored in correspondence to the identification information in the storage unit. An analyst arranges the one or more samples at predetermined position(s) in some or all of the plurality of sample arrangement units. The analyst also attaches, at the predetermined position of the sample arranging member, the identification information in correspondence to the batch file that is to be used for measuring the one or more samples. In order to do so, the analyst may write the identification information at the predetermined position of the sample arranging member, or attach a seal, having the identification information printed thereon, at the predetermined position. Alternatively, the analyst may write the identification information in the IC chip attached at the predetermined position. When the sample arranging member, having the identification information attached at the predetermined position, has been set in the auto-sampler, the identification information reader reads the identification information in the sample arranging member. The analysis controller reads out from the storage unit the batch file in correspondence to the identification information read by the identification information reader. Then, based on the description in the batch file, the analysis controller controls the auto-sampler and the analyzer to measure a corresponding one of the one or more samples.

As has been described above, in the analyzing system according to the first aspect of the present invention, the analysis controller reads out from the storage unit the batch file in correspondence to the identification information read by the identification information reader, and based on the batch file, corresponding one or more samples are sequentially measured. Accordingly, the analyst is free from reading out a wrong batch file at the start of measurement and from carrying out the measurement based on the wrong one. Thus, the analyst measures the one or more samples arranged in the sample arrangement units under a correct measurement condition.

In the analyzing system according to the first aspect,

the sample arranging member preferably includes:

a main body including the plurality of sample arrangement units; and

a template sheet which is a sheet to be removably attached to the main body, and is configured, in a state of being attached to the main body, to have the identification information attached at a position corresponding to the predetermined position.

In the analyzing system of this aspect, the identification information is attached to the template sheet, at the position corresponding to the predetermined position when the template sheet is attached to the main body. Then, the template sheet having the identification information is attached to the main body. The identification information is attached in a same method as the above. In this aspect, it is possible to carry out the following operations concurrently: to arrange the one or more samples in the plurality of sample arrangement units in the main body; and to attach the identification information to the template sheet. With this configuration, the analyst proceeds with the operations more efficiently.

Further, the template sheet preferably has sample information attached at predetermined positions of the template sheet, the predetermined positions being in correspondence to the some or all of the plurality of sample arrangement units. The sample information is configured to be set in a corresponding one of the plurality sample arrangement units.

In the analyzing system of this aspect, the analyst is less prone to arrange the one or more samples to wrong positions (instead of the right one to be arranged) in the some or all of the sample arrangement units.

In order to solve the problems previously described, a second aspect of the present invention provides an analyzing system including:

a storage unit configured to store a measurement condition for each of a plurality of samples;

a sample arranging member which is a member including a plurality of sample arrangement units each for arrangement of a sample, and to which sample information is to be attached at a predetermined position of the sample arranging member in correspondence to each of some or all of the plurality of sample arrangement units, the sample information being configured to identify a sample to be set in corresponding one of the some or all of the plurality of sample arrangement units;

an auto-sampler to which the sample arranging member is set, and which is configured to sequentially collect one or a plurality of samples arranged in some or all of the plurality of sample arrangement units;

a sample information reader configured to read the sample information in the sample arranging member that has been set to the auto-sampler;

a batch file creator configured to read out, from the storage unit, a measurement condition for each of the one or the plurality of samples that corresponds to the sample information read by the sample information reader, and configured to create a batch file by arranging the measurement conditions in a predetermined sequential order; and

an analysis controller configured, based on a description in the batch file, to control the auto-sampler and an analyzer to measure each of the one or the plurality of samples.

In the analyzing system according to the second aspect of the present invention, the measurement condition for each of the samples to be measured is previously stored in the storage unit. Additionally, at a position in correspondence to each of one or the plurality of sample arrangement units where the sample(s) is/are to be actually arranged, the sample identification information (e.g., a sample number or a sample name) is attached to identify the sample to be arranged in the corresponding sample arrangement unit. The sample information is, for example, described at the predetermined position or printed on a seal to be attached at the predetermined position.

Based on the sample information, the analyst arranges the samples respectively in the one or the plurality of sample arrangement units. When the sample arranging member has been set in the auto-sampler, the sample information reader reads the sample information. The batch file creator reads out, from the storage unit, the measurement condition for each of the one or the plurality of samples that correspond(s) to one piece or a plurality pieces of the sample information read by the sample information reader. Then, the batch file creator creates the batch file by arranging the measurement conditions in the predetermined sequential order (typically, in a sequential order where the auto-sampler collects each of the one or the plurality of samples). Based on the description in the batch file, the analysis controller controls the auto-sampler and the analyzer to sequentially measure each of the one or the plurality of samples.

As has been described above, in the analyzing system according to the second aspect of the present invention, the sample information is attached at the position in correspondence to each of the one or the plurality of sample arrangement units where the corresponding sample is arranged; the sample information is read, and based on the sample information, the measurement condition for the corresponding sample is read out from the storage unit; and the measurement conditions are arranged in the sequential order to collect the samples, so that the batch file is created. Then, based on the batch file created, the measurement is carried out. With this configuration, the analyst is free from setting a wrong measurement condition, and thus measures the sample(s) arranged in the sample arrangement unit(s) under the correct measurement condition(s).

In the analyzing system according to the second aspect too,

the sample arranging member preferably includes:

a main body including the plurality of sample arrangement units; and

a template sheet which is a sheet to be removably attached to the main body, and is configured, in a state of being attached to the main body, to have the sample information attached at a position corresponding to the predetermined position.

In order to solve the problems previously described, a third aspect of the present invention provides an auto-sampler template sheet to be used by being removably attached to a member that includes a plurality of sample arrangement units,

the auto-sampler template sheet including:

an identification information attachment unit to which identification information is attached, the identification information being configured to identify a batch file that is to be used for measuring one or more samples arranged in some or all of the plurality of sample arrangement units.

In order to solve the problems previously described, a fourth aspect of the present invention provides an auto-sampler template sheet to be used by being removably attached to a member that includes a plurality of sample arrangement units,

the auto-sampler template sheet including:

a sample information attachment unit to which sample information is attached at predetermined positions in correspondence to some or all of the plurality of sample arrangement units, the sample information being configured to identify a sample or samples to be set in the some or all of the plurality of sample arrangement units.

In order to solve the problems previously described, a fifth aspect of the present invention provides an auto-sampler to be used to collect a sample and introduce the sample into an analyzer,

the auto-sampler including:

a sample arranging member which is a member including a plurality of sample arrangement units for arrangement of samples, and to which identification information is attached at a predetermined position, the identification information being configured to identify a batch file that is to be used for measuring one or more samples arranged in corresponding some or all of the plurality of sample arrangement units.

In order to solve the problems previously described, a sixth aspect of the present invention provides an auto-sampler to be used to collect a sample and introduce the sample into an analyzer,

the auto-sampler including:

a sample arranging member which is a member including a plurality of sample arrangement units for arrangement of samples, and to which sample information is attached at a predetermined position in correspondence to each of some or all of the plurality of sample arrangement units, the sample information being configured to identify each of the samples to be set in corresponding one of the some or all of the plurality of sample arrangement units.

### Advantageous Effects of Invention

With the present invention, it is possible to measure samples set in a plurality of sample arrangement units of an auto-sampler under correct measurement conditions.

### BRIEF DESCRIPTION OF DRAWINGS

FIG. 1 is a configuration diagram of main part of an analyzing system according to a first embodiment of the present invention.

FIG. 2 is an example of a standard method file in each of the analyzing system according to the first embodiment and an analyzing system according to a second embodiment.

FIG. 3 is an example of an analysis method file in the analyzing system according to each of the first embodiment and the second embodiment.

FIG. 4 is an example of a batch file in the analyzing system according to each of the first embodiment and the second embodiment.

FIG. 5 is a schematic configuration diagram of an auto-sampler used in the analyzing system according to each of the first embodiment and the second embodiment.

FIG. 6 is a top view of a sample rack of the auto-sampler used in the analyzing system according to the first embodiment.

FIGS. 7A and 7B are examples of an auto-sampler template sheet used in the analyzing system according to the first embodiment.

FIG. 8 is a configuration diagram of main part of the analyzing system according to the second embodiment.

FIGS. 9A and 9B are examples of an auto-sampler template sheet used in the analyzing system according to the second embodiment.

FIG. 10 is an auto-sampler template sheet according to a modification of the present invention.

FIG. 11 is a schematic configuration diagram of an auto-sampler according to the modification when the auto-sampler template sheet according to the modification is used.

FIG. 12 is an example of an auto-sampler template sheet used for a sample well.

### DESCRIPTION OF EMBODIMENTS

An analyzing system, an auto-sampler, and an auto-sampler template sheet, each according to an embodiment of the present invention, will be described with reference to the drawings.

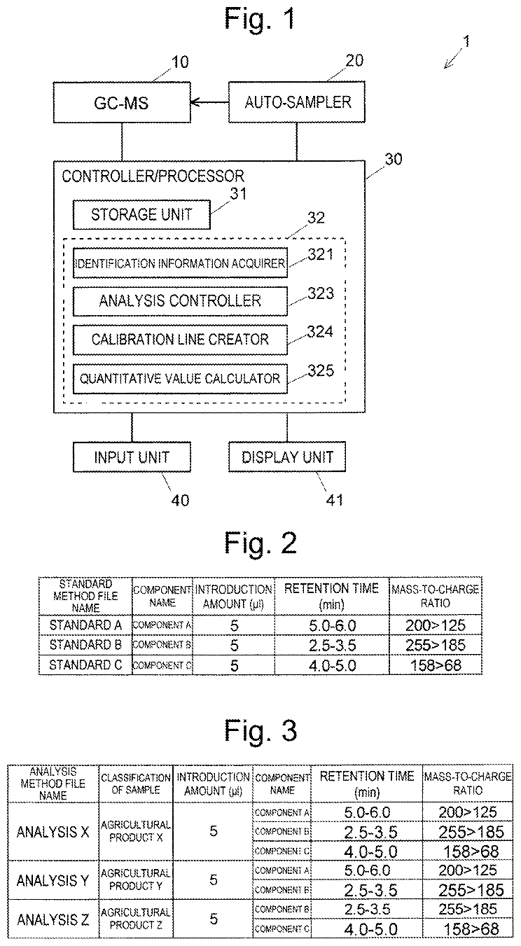

FIG. 1 is a schematic configuration diagram of an analyzing system including an auto-sampler template sheet and an auto-sampler according to a first embodiment. An analyzing system 1 of this embodiment includes a gas chromatograph mass spectrometer (GC-MS) 10, an auto-sampler 20, and a controller/processor 30. In the analyzing system 1, a plurality of samples set in the auto-sampler 20 are, in a predetermined sequential order and timing, collected and introduced into the gas chromatograph mass spectrometer 10 to be measured. As a result, mass chromatogram data is obtained. Based on the mass chromatogram data, a target component contained in each of the plurality of samples is quantitated.

The controller/processor 30 includes a storage unit 31, and further includes an identification information acquirer 321, an analysis controller 323, a calibration line creator 324, and a quantitative value calculator 325, each serving as a functional block. The controller/processor 30 is actually a personal computer, and a central processing unit (CPU) of the personal computer executes a quantitative analysis program 32 to embody each of the functional blocks.

The storage unit 31 stores a plurality of batch files. In the batch file, measurement conditions and a measurement order are described for a sample set including one or more samples. The file that describes the measurement condition for each of the samples is referred to as a method file. The method file is divided into two types: a standard method file and an analysis method file.

The standard method file describes the measurement condition for measuring a standard sample in the gas chromatograph mass spectrometer 10. The standard sample contains one or more known target components at known concentration(s). FIG. 2 shows an example of the standard method file. Standard method files A, B, and C are used for measuring standard samples A1 to A4 containing a known component A, standard samples B1 to B4 containing a known component B, and standard samples C1 to C4 containing a known component C, respectively. The standard method file describes the measurement condition including: a file name (standard A, standard B, and standard C); a component name to be measured (a component A, a component B, and a component C); an introduction amount (5 up of each of the standard samples to be introduced into the gas chromatograph mass spectrometer 10 from the auto-sampler 20; a period of time (retention time) taken for each of the components to elute from a column; and a mass-to-charge ratio of an ion to be generated from the corresponding component (MRM transition as a combination of the mass-to-charge ratios of a precursor ion and a product ion). In FIG. 2 and FIG. 3 to be described later, a denotation such as “200>125” indicates that the mass-to-charge ratio of the precursor ion is 200 and the mass-to-charge ratio of the product ion is 125.

The analysis method file describes the measurement condition for measuring one or more known target components contained in each of the samples to be analyzed (hereinafter, referred to as an analysis target sample) in the gas chromatograph mass spectrometer 10. As shown in FIG. 3, the analysis method file describes the measurement condition including: classification of the sample (an agricultural product X, an agricultural product Y, and an agricultural product Z) for which the analysis method file is to be used; a file name (analysis X, analysis Y, and analysis Z); a name of a component (i.e., target component) in the analysis target samples to be measured and quantitated (the component A, the component B, and the component C); retention time of the target component; and a mass-to-charge ratio of the target component (MRM transition as the combination of the mass-to-charge ratios of the precursor ion and the product ion).

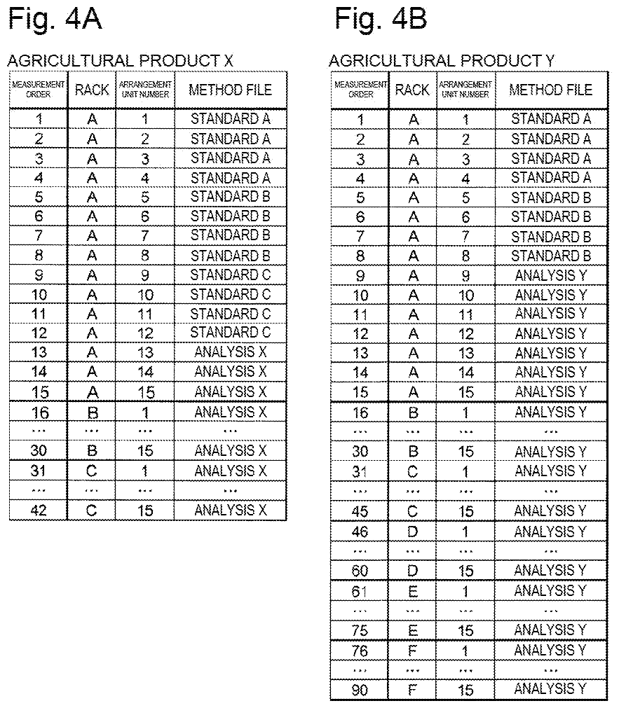

FIG. 4 shows an example of the batch files stored in the storage unit 31 in this embodiment. The batch file in FIG. 4A is used to measure a total of 42 samples: 30 samples classified as the agricultural product X together with the standard samples A1 to A4, the standard samples B1 to B4, and the standard samples C1 to C4. The batch file in FIG. 4B is used to measure a total of 90 samples: 82 samples classified as the agricultural product Y together with the standard samples A1 to A4 and the standard samples B1 to B4. Each of the batch files describes information for the sequential order to collect the one or more samples arranged respectively in a sample arrangement unit 27 of a sample rack 22 (see FIG. 6), and the method file to be used for measuring each of these samples in the sequential order.

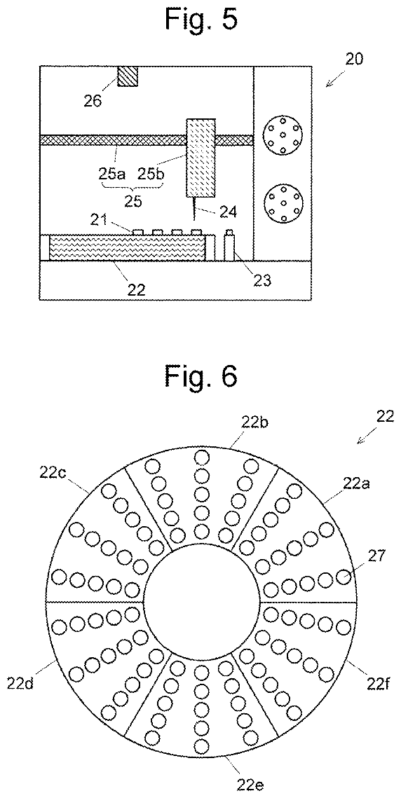

FIG. 5 shows a schematic configuration inside the auto-sampler 20 of this embodiment. The auto-sampler 20 accommodates the sample rack 22 (corresponding to a sample arranging member in the present invention). At a predetermined position of the sample rack 22, each of vials 21 containing the samples is set. The auto-sampler 20 accommodates an injection port 23, a washing port (not shown), and a drain (not shown), each positioned at side of the sample rack 22. The auto-sampler 20 also accommodates, at its upper part, a sampling needle 24, and a sampling needle-moving mechanism 25 for moving the sampling needle 24 horizontally and vertically. The sampling needle-moving mechanism 25 includes a guide rail 25a and a moving unit 25b that moves along the guide rail 25a. The moving unit 25b has a motor built therein, and the motor is operated to cause the moving unit 25b to move and cause the sampling needle 24 to move up and down. Subsequently, the sample contained in each of the vials 21 is collected from a tip of the sampling needle 24 to be injected into the injection port 23. Further, the auto-sampler 20 accommodates, on its upper wall surface, a camera 26 at a position where an entire upper surface of the sample rack 22 is captured within field of view of the camera 26.

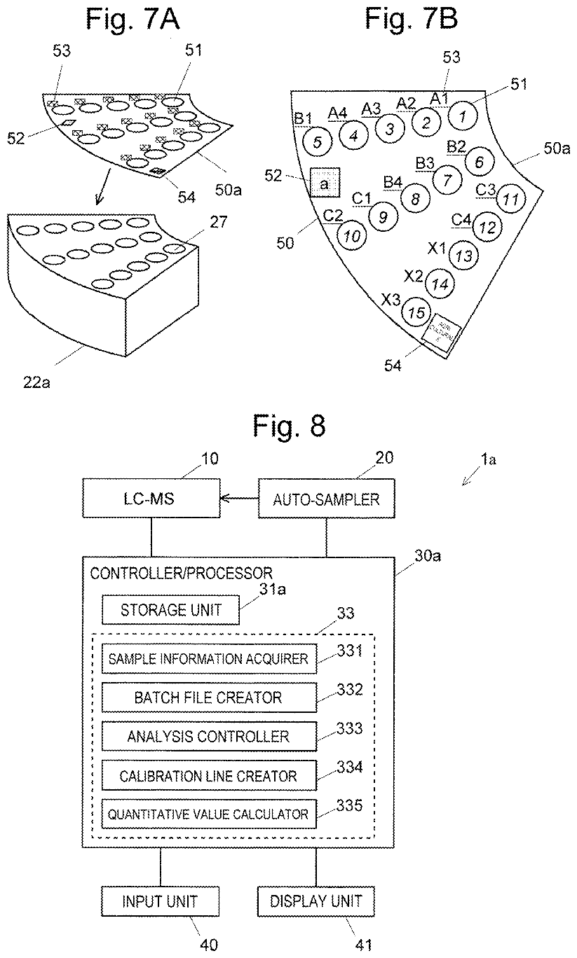

FIG. 6 is a top view of the sample rack 22. The sample rack 22 includes partial sample racks 22a, 22b, 22c, 22d, 22e, and 22f, six in total and each having an identical shape to the others. Each of the partial sample racks 22a to 22f concentrically includes the sample arrangement units 27 as recessed portions where the vials 21 are respectively arranged. It is possible to accommodate as many as 15 of the vials 21 in each of the partial sample racks 22a to 22f Accordingly, in the sample rack 22, it is possible to accommodate as many as 90 of the vials 21 in total. In this embodiment, the samples are arranged in 42 out of 90 of the sample arrangement units 27. Further, the sample arrangement units 27 in each of the partial sample racks 22a to 22f are numbered from 1 to 15 as accommodating numbers (see FIG. 7B).

As shown in FIG. 7A, in this embodiment, the partial sample racks 22a to 22f respectively have, on upper surfaces, auto-sampler template sheets 50a, 50b, 50c, 50d, 50e, and 50f attached. (Each of FIGS. 7A and 7B only shows the partial sample rack 22a and the auto-sampler template sheet 50a.) The auto-sampler template sheets 50a to 50f respectively have an identical shape to the upper surfaces of the partial sample racks 22a to 22f, and include openings 51 in correspondence to the sample arrangement units 27.

The auto-sampler template sheet 50a includes the openings 51 in correspondence to the sample arrangement units 27 of the partial sample rack 22a, and sample information attachment units (corresponding to sample information description columns in this embodiment), each of which is provided at a predetermined position with respect to the corresponding opening 51 (on the left of the corresponding opening 51). At each of the sample information attachment units, sample information 53 is described to identify the sample to be arranged in the corresponding opening 51 (in the corresponding sample arrangement unit 27 of the partial sample rack 22a). In this embodiment, the standard samples A1 to A4, B1 to B4, and C1 to C4 containing the target components A, B, and C at different concentrations, are set at positions where the sample information 53, i.e., A1 to A4, B1 to B4, and C1 to C4, is described in red (underlined in the drawing), respectively. Additionally, analysis target samples X1 to X3 are set at positions where X1 to X3 are described in black, respectively. With this configuration, an analyst correctly arranges a standard sample and a correct analysis target sample in each of the sample arrangement units 27.

The auto-sampler template sheet 50a includes, at another predetermined position thereof (at its peripheral corner in this embodiment), an identification information attachment unit (corresponding to an identification information description column in this embodiment). At the identification information attachment unit, identification information 54 is described to identify the batch file. The auto-sampler template sheet 50a also has at further another predetermined position thereof (in a vicinity of its peripheral center in this embodiment), block information 52 attached (described). The block information 52 indicates that the auto-sampler template sheet 50a is to be attached to the partial sample rack 22a. With this configuration, the auto-sampler template sheets 50a to 50f of identical shape are attached to the partial sample racks 22a to 22f without being mistaken, respectively.

The block information 52 is attached to the other partial sample racks 22b to 22f, and is attached to the auto-sampler template sheets 50b to 50f (that are to be respectively attached to the partial sample racks 22b to 220. Additionally, the analysis target sample is to be set in the partial sample racks 22b and 22c, so that the sample information 53 is also attached to the auto-sampler template sheets 50b and 50c (that are to be respectively attached to the partial sample racks 22b and 22c). In this embodiment, the batch file describes the measurement order and the measurement conditions for the samples in all of the partial sample racks 22a to 22f; and thus, based on the identification information 54 attached to the auto-sampler template sheet 50a only, the batch file is identified. However, when the batch file describes the measurement order and the measurement conditions for the samples in each of the partial sample racks 22a to 22f, the identification information 54 is attached to each of the auto-sampler template sheets 50a to 50f. Then, the auto-sampler template sheets 50a to 50f are attached to the partial sample racks 22a to 22f where the samples are arranged, respectively. Further, in this embodiment, the auto-sampler template sheets 50a to 50f each have the identical shape to the upper surface of the partial sample racks 22a to 22f, but may have other shape, such as a shape to entirely cover the upper surface of the partial sample racks 22a to 22f, and be placed over the upper surface of the partial sample racks 22a to 22f

Next, a case, where the analyzing system of this embodiment is used to quantitate the analysis target samples, will be illustratively described. In this case, the analyzing system quantitates the component A, the component B, and the component C that are contained in each of 30 analysis target samples X1 to X30 collected from the agricultural product X.

The analyst prepares standard samples to be measured and quantitated as follows: four types of standard samples, each containing the component A at different concentration from the others; four types of standard samples, each containing the component B at different concentration from the others; and four types of standard samples, each containing the component C at different concentration from the others. Then, the analyst introduces the standard samples respectively into the vials 21. Each of the target components contained in the standard samples is at known concentration. The vials 21 containing the standard samples are respectively labeled with A1 to A4, B1 to B4, and C1 to C4 in red. In this embodiment, the standard samples are indicated in red. Additionally, the 30 analysis target samples X1 to X30 are respectively introduced into the vials 21, and these vials 21 are labeled with X1 to X30 in black. In this embodiment, the analysis target samples are indicated in black. Here, 42 of the vials containing the standard samples or the analysis target samples have been prepared.

Subsequently, the analyst attaches the auto-sampler template sheets 50a to 50c (that have been previously prepared) to the partial sample racks 22a to 22c, respectively. In this embodiment, 42 of the vials are to be subjected to the measurement, and it is possible to accommodate as many as 15 of the vials in each of the partial sample racks 22a to 22f Thus, as has been described above, the vials 21 are accommodated in the partial sample racks 22a to 22c (three partial sample racks) only. For this reason, only the partial sample racks 22a to 22c have the auto-sampler template sheets 50a to 50c attached thereon. The auto-sampler template sheets 50a to 50c may be created by the analyst, but when the analyst is not familiar with measurements or analyses of samples, the auto-sampler template sheets 50a to 50c may be previously created by someone in charge of the analyses.

As has been described above, the auto-sampler template sheets 50a to 50c respectively have, at the upper surface peripheries thereof, the block information 52 indicating the partial sample racks 22a to 22f Also, the auto-sampler template sheets 50a to 50c respectively have, on the upper surfaces thereof, the openings 51 in a vicinity of the sample information attachment units; and at each of the sample information attachment units, the sample information 53 is described to identify the sample (the standard sample or the analysis target sample) to be inserted into the corresponding sample arrangement unit 27 (the corresponding opening 51). In accordance with the information above, the analyst sets the vials 21 in the sample arrangement units 27 of the partial sample racks 22a to 22c. Then, the analyst sets the partial sample racks 22a to 22f in the auto-sampler 20.

When the analyst commands start of the measurement by operating an input unit 40 or the like, the identification information acquirer 321 operates the camera 26 to capture an image of the entire upper surface of the sample rack 22. The partial sample racks 22a to 22f are set at known positions of the auto-sampler 20, and the sample arrangement units 27 (the number of which is 15) are set at known positions in each of the partial sample racks 22a to 22f Accordingly, it is possible to acquire the identification information 54 based on an analysis of the image captured by the camera 26. In this embodiment, as the identification information 54, “agricultural X” is obtained. In other words, in the first embodiment, the identification information acquirer 321 and the camera 26 correspond to an identification information reader in the present invention.

When having obtained the “agricultural X” as the identification information 54, the analysis controller 323 reads out, among the batch files stored in the storage unit 31, the “agricultural product X” as a batch file corresponding to the “agricultural X”. Then, in the sequential order described in the batch file (agricultural product X; see FIG. 4A), the auto-sampler 20 collects the samples and the gas chromatograph mass spectrometer 10 measures the samples. At the gas chromatograph mass spectrometer 10, measurement data (the mass chromatogram data) for each of the samples is obtained. The measurement data (mass chromatogram data) is sequentially stored in the storage unit 31.

In this embodiment, the identification information 54 is acquired as text information, based on which the batch file is identified. This form is merely an example, and the identification information 54 may be acquired as image information. In that case, information that corresponds the image used as the identification information 54 with the batch file is previously stored in the storage unit 31. The image acquired is applied to the information, and based on the identification information 54 described in the auto-sampler template sheet 50a in the partial sample rack 22a, the batch file is identified. In other words, as the identification information 54, various information, which has been obtained by combining one or more of characters, symbols, display colors, and images, may be used. Note that, as in this embodiment, when the identification information 54 includes asymmetric characters or the like, a side on which the characters are recognized is easily confirmed as a front surface. On the other hand, when symmetric characters, symbols, or images are used as the identification information 54, in order to prevent the front surface from being mistaken for a rear surface or vice versa, the auto-sampler template sheets 50a to 50f may preferably have a denotation or a slit indicating top to bottom, left to right, or front to rear.

When the analysis controller 323 has completed all the measurements described in the batch file, the calibration line creator 324 creates a mass chromatogram based on the mass chromatogram data obtained for each of the standard samples A1 to A4 and displays the mass chromatograms at a display unit 41. Further, the calibration line creator 324 obtains an area of a peak in each of the mass chromatograms. Then, based on a relationship between a concentration of each of the standard samples A1 to A4 and the area of the peak in the mass chromatogram for the corresponding standard sample, the calibration line creator 324 creates a calibration line for the component A. Similarly, based on relationships between concentrations of the standard samples B1 to B4 and the areas of the peaks in the corresponding mass chromatograms respectively, and based on relationships between concentrations of the standard samples C1 to C4 and the areas of the peaks in the corresponding mass chromatograms respectively, the calibration line creator 324 creates a calibration line for the component B and a calibration line for the component C. Then, the calibration lines for the component A, the component B, and the component C are respectively displayed at the display unit 41. In this embodiment, each of the standard samples contains only one type of component, showing only a single peak in the chromatogram. Thus, operations, such as dividing the chromatogram to extract the peak, are not required. When it is difficult to fully segregate one component from the others at preparing the standard samples, or when the standard samples containing a plurality of known components at known concentrations are used, a part corresponding to retention time for each component is extracted from the whole chromatogram such that the area of the peak is obtained.

Having obtained the calibration line for each of the component A, the component B, and the component C, the quantitative value calculator 325 creates a mass chromatogram based on the mass chromatogram data obtained for each of the analysis target samples X1 to X30, and displays the mass chromatogram on a screen of the display unit 41. Further, the quantitative value calculator 325 extracts a peak from each of the mass chromatograms to obtain an area of the peak. The analysis target samples X1 to X30 contain (or possibly contain) the component A, the component B, or the component C. Thus, the quantitative value calculator 325 extracts a part corresponding to retention time for each of the component A, the component B, and the component C from the chromatograms. The quantitative value calculator 325 identifies a peak within a range of the retention time as a peak for each of the components A, components B, and components C, and obtains an area of each of the peaks. Then, by applying the area of each of the peaks to the calibration line that the calibration line creator 324 has created, the quantitative value calculator 325 obtains a quantitative value for each of the component A, the component B, and the component C contained in the analysis target samples X1 to X30, and displays the result obtained on the screen of the display unit 41.

Various types of samples are measured in a chromatograph mass spectrometer. Accordingly, a large number of batch files for describing various measurement conditions in accordance with the types of samples are stored in the storage unit 31. In a conventional analyzing system, the analyst autonomously reads out the batch files at start of the measurements. Here, the analyst may read out a wrong one of the batch files and carry out the measurement based on the wrong one.

In contrast, in the analyzing system of the first embodiment, the analysis controller 323 reads out, from the storage unit 31, the batch file corresponding to the identification information 54 that the identification information acquirer 321 has acquired, and the samples are sequentially measured. Accordingly, the analyst is free from reading out a wrong one of the batch files at the start of measurement and to carry out the measurement based on the wrong one. Thus, the analyst measures each of the one or more samples arranged in the sample arrangement units under a correct measurement condition.

Next, an analyzing system according to another embodiment (second embodiment) of the present invention will be described. FIG. 8 is a schematic configuration diagram of the analyzing system including an auto-sampler according to the second embodiment and an auto-sampler template sheet according to the second embodiment. As in the first embodiment, an analyzing system 1a of the second embodiment includes a gas chromatograph mass spectrometer (GC-MS) 10, an auto-sampler 20, and a controller/processor 30a.

The controller/processor 30a includes a storage unit 31a, and further includes a sample information acquirer 331, a batch file creator 332, an analysis controller 333, a calibration line creator 334, and a quantitative value calculator 335, each serving as a functional block. The controller/processor 30a is actually a personal computer, and a central processing unit (CPU) of the personal computer executes a quantitative analysis program 33 to embody each of the functional blocks.

In the first embodiment, the storage unit 31 stores the batch files. In the second embodiment, the storage unit 31a stores the standard method files (standard A, standard B, and standard C) described with reference to FIG. 2, and the analysis method files (analysis X, analysis Y, and analysis Z) described with reference to FIG. 3.

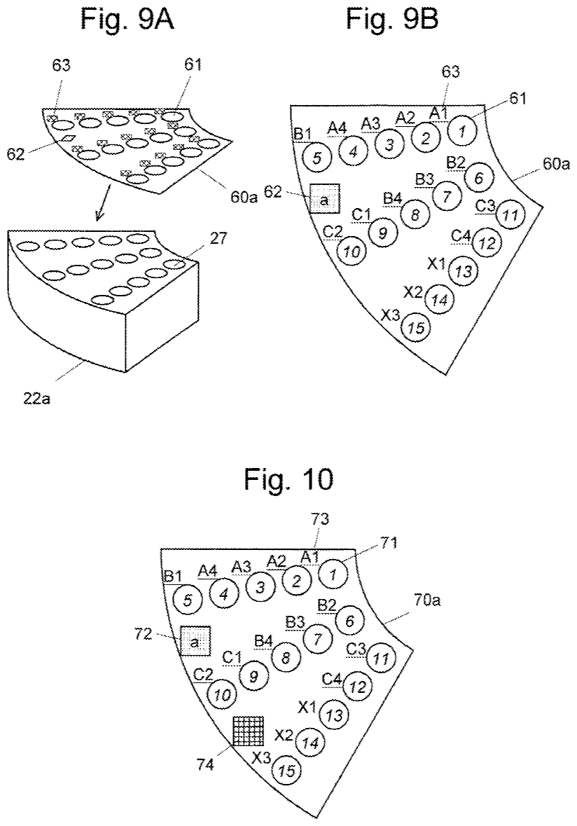

In the second embodiment, as shown in FIGS. 9A and 9B, auto-sampler template sheets 60a to 60f are used (FIG. 9A and FIG. 9B show the auto-sampler template sheet 60a only). In the first embodiment, the auto-sampler template sheet 50a has the block information 52, the sample information 53, and the identification information 54 attached (described) thereon. In the second embodiment, the auto-sampler template sheet 60a has only block information 62 and sample information 63 attached (described) thereon. As in the first embodiment, the block information 62 is configured to identify a partial sample rack 22a to which the auto-sampler template sheet 60a is to be attached, and the sample information 63 is configured to identify a sample to be arranged in an opening 61 in correspondence to (positioned in a vicinity of) the sample information 63.

Next, a procedure, where the analyzing system of the second embodiment is used to quantitate a target component contained in an analysis target sample, will be described. As in the first embodiment, a case where the analyzing system quantitates the component A, the component B, and the component C will be illustratively described. The components A to C are contained in each of 30 analysis target samples X1 to X30 collected from an agricultural product X. A detailed description of same procedures as in the first embodiment will be omitted as appropriate.

As in the first embodiment, based on the block information 62, an analyst attaches the auto-sampler template sheets 60a to 60c to the partial sample racks 22a to 22c, respectively (the analyst may alternatively attach all the auto-sampler template sheets 60a to 60f). Further, based on the sample information 63, the analyst arranges each of the samples in a corresponding one of sample arrangement units 27 in the partial sample racks 22a to 22c. Then, the analyst sets the partial sample racks 22a to 22c in the auto-sampler 20.

When the analyst commands start of a measurement by operating an input unit 40 or the like, the sample information acquirer 331 operates a camera 26 to capture an image of an entire upper surface of a sample rack 22. The partial sample racks 22a to 22f are set at known positions of the auto-sampler 20, and the sample arrangement units 27 (the number of which is 15) are set at known positions in each of the partial sample racks 22a to 22f Accordingly, based on an analysis of the image captured by the camera 26, it is possible to identify a position of each of the openings 61 (sample arrangement units 27) in the image. Note that, when the partial sample racks 22a to 22f are rotatably arranged in the auto-sampler 20, by reading the block information 62 (for the sample rack 22) described on a peripheral edge of an upper surface of each of the auto-sampler template sheets 60a to 60c, it is possible to identify a position of each of the partial sample racks 22a to 22f in addition to the positions of the sample arrangement units 27 in the corresponding partial sample racks.

When the position of each of the partial sample racks 22a to 22c and the positions of the sample arrangement units 27 in the corresponding partial sample rack have been identified, the sample information acquirer 331 further reads, based on the analysis of the image, the sample information 63 with respect to each of the openings 61 (the sample information 63 positioned in the vicinity of each of the openings 61) in correspondence to the sample arrangement units 27. In the second embodiment, the sample information 63 is extracted as text information, and based on text information, the sample (a standard sample or the analysis target sample) contained in each of the sample arrangement units 27 is identified. Alternatively, the sample information 63 may be acquired as image information. In that case, information that corresponds the image used as the sample information 63 with the standard sample or the analysis target sample is previously stored in the storage unit 31a. Then, the sample information 63 is applied to the information, based on which the sample (the standard sample or the analysis target sample) contained in each of the sample arrangement units 27 is identified. In other words, as the sample information 63, various information, which has been obtained by combining one or more of characters, symbols, display colors, and images, may be used. As in this embodiment, when the sample information 63 includes asymmetric characters or the like, a side on which the characters are recognized is easily confirmed as a front surface. On the other hand, when symmetric characters, symbols, or images are used as the sample information 63, as in the first embodiment, in order to prevent the front surface from being mistaken for a rear surface or vice versa, the auto-sampler template sheets 60a to 60f may preferably have a denotation or a slit indicating top to bottom, left to right, or front to rear.

When the standard sample or the analysis target sample contained in each of the sample arrangement units 27 has been identified based on the sample information acquired by the sample information acquirer 331, the batch file creator 332 reads out the standard method files stored in the storage unit 31a to correspond the standard method files respectively with the standard samples. Additionally, the batch file creator 332 reads out the analysis method files stored in the storage unit 31a to correspond the analysis method files respectively with the analysis target samples. Then, the batch file creator 332 creates the batch files arranged in a sequential order according to numbers given to the sample arrangement units 27 (e.g., A1, A2, . . . A15, B1, B2, . . . ), and stores the batch files in the storage unit 31a. As a result, the same batch files as those described with reference to FIG. 4A are created. In this embodiment, the samples are predetermined to be measured (the samples are predetermined to be collected by the auto-sampler 20) in the sequential order according the numbers given to the sample arrangement units 27. The analyst may appropriately rearrange the sets of the samples and measurement conditions of the samples (described in the batch file) to change the measurement order of the samples. Further, it is possible not only to continuously measure all the samples set in the auto-sampler 20 at once but also to continuously measure every group of the samples; for example, when 90 of the samples are set in the auto-sampler 20, the samples are divided into groups of 30 and every group of the samples are continuously measured.

When the batch file creator 332 has created the batch file, the analysis controller 333 causes the auto-sampler 20 to collect the samples in the sequential order described in the batch file and causes the gas chromatograph mass spectrometer 10 to sequentially measure the samples. As a result of the measurements, mass chromatogram data is obtained. Then, in the measurement order described in the batch file, the mass chromatogram data is sequentially stored in the storage unit 31a as mass chromatogram data for the standard samples or for the analysis target samples.

When the analysis controller 333 has completed all the measurements described in the batch file, the calibration line creator 334 creates a calibration line based on the mass chromatogram of each of the standard samples, and the quantitative value calculator 335 quantitates the components A to C contained in each of the analysis target samples. Each of the calibration line creator 334 and the quantitative value calculator 335 operates as in the first embodiment.

In the analyzing system 1 of the second embodiment, the sample information is attached to a position or positions in correspondence to one or more sample arrangement units where the sample or samples is/are arranged. Then, the sample information is read, and the measurement condition for each of the samples is read out from the storage unit; and the sample information and the measurement condition for each of the samples are arranged in the sequential order to collect the samples, so that the batch file is created. The analysis controller measures each of the samples in the measurement order and under the measurement condition, both described in the batch file. With this configuration, the analyst is free from setting a wrong measurement condition, and thus measures the sample(s) arranged in the sample arrangement unit(s) under the correct measurement condition(s).

The foregoing embodiments are merely illustrative, and not restrictive of the present invention; thus, any change or modification appropriately made within the spirit of the present invention will naturally fall within the scope of claims of the present invention. As a case of the first embodiment, each batch file is identified based on the identification information 54; and as a case of the second embodiment, a method file of each of the samples is identified based on the sample information 63. Alternatively, these cases may be combined. For example, the batch files may be stored in the storage unit, and the auto-sampler template sheets 60a to 60f of the second embodiment may be used. In this case, based on a plurality of the sample information 63 (a plurality of sample information descriptions) on the auto-sampler template sheets 60a to 60f, among the batch files that describe the measurement conditions for the plurality of samples, a corresponding batch file is identified; and each of the plurality of samples is measured under the measurement condition described in the corresponding batch file. Here, the sample information is used as the identification information.

Further, in the first embodiment, the camera 26 inside the auto-sampler 20 captures the image of the identification information 54 attached to the auto-sampler template sheets 50a to 50f, and based on the analysis of the image captured, the identification information is acquired; in the second embodiment, the camera 26 inside the auto-sampler 20 captures the image of the sample information 63 attached to the auto-sampler template sheets 60a to 60f, and based on the analysis of the image captured, the sample information is acquired. Alternatively, by using other means than a camera, the identification information and the sample information may be acquired. FIG. 10 shows an example of the other means.

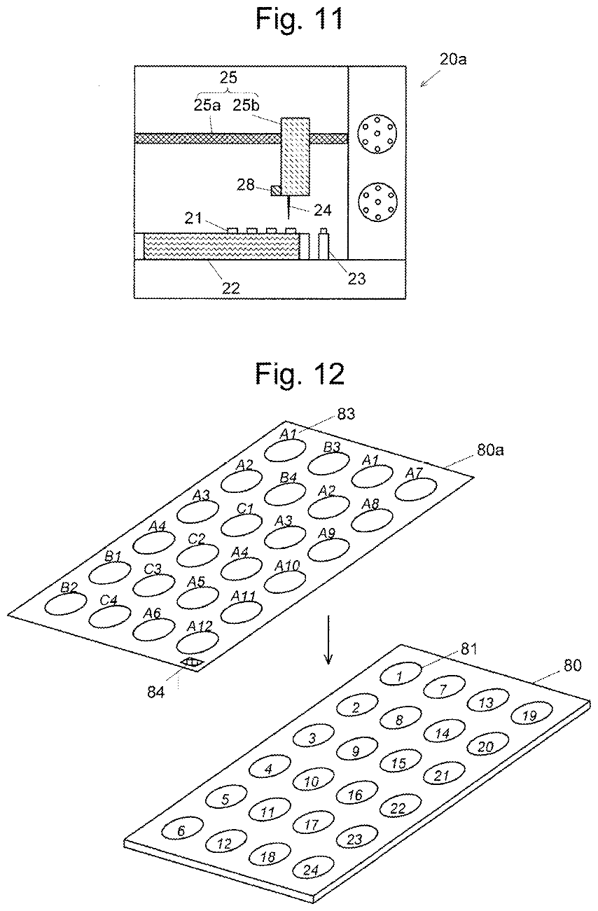

FIG. 10 shows an auto-sampler template sheet 70a of a modification. As with the auto-sampler template sheet 50a of the first embodiment described with reference to FIG. 6B, the auto-sampler template sheet 70a has openings 71 provided respectively in correspondence to sample arrangement units 27. At each of the openings 71, a corresponding one of sample information 73 is provided. Further, the auto-sampler template sheet 70a includes an IC chip 74 (identification information holder) in which the identification information is written, and block information 72. As shown in FIG. 11, an auto-sampler 20a internally includes an IC chip reader 28 (information reader) instead of the camera 26 of the first and second embodiments. The IC chip reader 28 is attached, for example, to the moving unit 25b. Then, the IC chip reader 28 is configured to move top to bottom and left to right to carry out short-range wireless communication with the IC chip 74 provided in each of the partial sample racks 22a to 22f, so that the information stored in the IC chip 74 is read out. In this case, the identification information is written in a single IC chip 74, but alternatively, the sample information may be written in a plurality of IC chips, each of which is to be provided in a vicinity of the openings 71 to be read out by the IC chip reader 28.

In each of the examples described above, the samples contained in the plurality of vials 21 in the sample rack 22 are collected and measured in the gas chromatograph mass spectrometer 10. Alternatively, instead of a gas chromatograph mass spectrometer, the following may be used: a gas chromatograph including a hydrogen flame ionization detector (FID), a thermal conductivity detector (TCD), an electron capture detector (ECD), or the like; or a liquid chromatograph including a mass spectrometer or a spectrophotometer as a detector. Still alternatively, the auto-sampler may be configured to introduce the samples to other analyzers (e.g., a spectrometry system). Further, in each of the examples described above, the auto-sampler template sheets 50a to 50f and 60a are attached to the sample rack 22 (partial sample racks 22a to 220. Alternatively, as shown in FIG. 12, a sample plate 80 including a plurality of wells 81 may use an auto-sampler template sheet 80a; and the auto-sampler template sheet 80a includes sample information 83, and an IC chip 84 in which the identification information is written.

Further, in the first and second embodiments, the auto-sampler template sheets 50a to 50f and 60a to 60f are attached to the partial sample racks 22a to 22f Alternatively, each of the identification information and the sample information may be directly written in the partial sample racks 22a to 22f, or may be described on a seal that is to be attached to the partial sample racks 22a to 22f

### REFERENCE SIGNS LIST

1, 1a . . . Analyzing System
10 . . . Gas Chromatograph Mass Spectrometer
20, 20a . . . Auto-Sampler
21 . . . Vial
22 . . . Sample Rack
22a to 22f . . . Partial Sample Rack
23 . . . Injection Port
24 . . . Sampling Needle
25 . . . Sampling Needle-Moving Mechanism
25a . . . Guide Rail
25b . . . Moving Unit
26 . . . Camera
27 . . . Sample Arrangement Unit
28 . . . IC Chip Reader
30, 30a . . . Controller/Processor
31, 31a . . . Storage Unit
32, 33 . . . Quantitative Analysis Program
321 . . . Identification Information Acquirer
323, 333 . . . Analysis Controller
324, 334 . . . Calibration Line Creator
325, 335 . . . Quantitative Value Calculator
331 . . . Sample Information Acquirer
332 . . . Batch File Creator
40 . . . Input Unit
41 . . . Display Unit
50a to 50f, 60a to 60f, 70a, 80a . . . Auto-Sampler Template Sheet
51, 61, 71 . . . Opening
52, 62, 72 . . . Block Information
53, 63, 73, 83 . . . Sample Information
54 . . . Identification information
74, 84 . . . IC Chip
80 . . . Sample Plate
81 . . . Well

1. An analyzing system comprising:
a storage unit configured to store a plurality of batch files, each of which describes a measurement order of one or more samples and a measurement condition for each of the one or more samples, and identification information in correspondence to each of the plurality of batch files;
a sample arranging member which is a member including a plurality of sample arrangement units each for arrangement of a sample, and has identification information attached at a predetermined position of the sample arranging member, the identification information being in correspondence to a batch file to be used for measuring one or more samples arranged in some or all of the plurality of sample arrangement units;
an auto-sampler to which the sample arranging member is set, and which is configured to sequentially collect one or more samples arranged in the some or all of the plurality of sample arrangement units;
an identification information reader configured to read the identification information in the sample arranging member which has been set to the auto-sampler,
an analysis controller configured to read out, from the storage unit, the batch file which corresponds to the identification information read by the identification information reader, and configured, based on a description in the batch file, to control the auto-sampler and an analyzer to measure the one or more samples.

2. The analyzing system according to claim 1, wherein
the sample arranging member includes:
a main body including the plurality of sample arrangement units; and
a template sheet which is a sheet to be removably attached to the main body, and is configured, in a state of being attached to the main body, to have the identification information attached at a position corresponding to the predetermined position.

3. The analyzing system according to claim 2, wherein
the template sheet has sample information attached at predetermined positions of the template sheet, the predetermined positions being in correspondence to the some or all of the plurality of sample arrangement units, the sample information being configured to identify each of the one or more samples to be set in a corresponding one of the plurality sample arrangement units.

4. The analyzing system according to claim 3, wherein the sample information is used as the identification information.

5. The analyzing system according to claim 1, wherein
the identification information reader includes:
an image capturing unit configured to capture an image of the identification information; and
an identification information acquirer configured to analyze the image captured by the image capturing unit in order to acquire the identification information.

6. The analyzing system according to claim 1, wherein
the identification information is electronically described in an IC chip attached to the sample arranging member, and
the identification information reader reads out the identification information in short-range wireless communication with the IC chip.

7. An analyzing system comprising:
a storage unit configured to store a measurement condition for each of a plurality of samples;
a sample arranging member which is a member including a plurality of sample arrangement units each for arrangement of a sample, and to which sample information is to be attached at a predetermined position of the sample arranging member in correspondence to each of some or all of the plurality of sample arrangement units, the sample information being configured to identify a sample to be set in corresponding one of the some or all of the plurality of sample arrangement units;
an auto-sampler to which the sample arranging member is set, and which is configured to sequentially collect one or a plurality of samples arranged in the some or all of the plurality of sample arrangement units;
a sample information reader configured to read the sample information in the sample arranging member which has been set to the auto-sampler;
a batch file creator configured to read out, from the storage unit, a measurement condition for each of the one or the plurality of samples which corresponds to the sample information read by the sample information reader, and configured to create a batch file by arranging the measurement conditions in a predetermined sequential order; and
an analysis controller configured, based on a description in the batch file, to control the auto-sampler and an analyzer to measure each of the one or the plurality of samples.

8. The analyzing system according to claim 7, wherein
the sample arranging member includes:
a main body including the plurality of sample arrangement units; and
a template sheet which is a sheet to be removably attached to the main body, and is configured, in a state of being attached to the main body, to have the sample information attached at a position corresponding to the predetermined position.

9. The analyzing system according to claim 7, wherein
the sample information reader includes:
an image capturing unit configured to capture an image of the sample information; and
a sample information acquirer configured to analyze the image captured by the image capturing unit in order to acquire the sample information.

10. The analyzing system according to claim 7, wherein
the sample information is electronically described in an IC chip attached to the sample arranging member, and
the sample information reader reads out the sample information in short-range wireless communication with the IC chip.

11. An auto-sampler template sheet to be used by being removably attached to a member which includes a plurality of sample arrangement units,
the auto-sampler template sheet comprising:
an identification information attachment unit to which identification information is attached, the identification information being configured to identify a batch file which is to be used for measuring each of one or more samples arranged in some or all of the plurality of sample arrangement units.

12. An auto-sampler template sheet to be used by being removably attached to a member which includes a plurality of sample arrangement units,
the auto-sampler template sheet comprising:
a sample information attachment unit to which sample information is attached at predetermined positions in correspondence to some or all of the plurality of sample arrangement units, the sample information being configured to identify a sample or samples to be set in each of the some or all of the plurality of sample arrangement units.

13. An auto-sampler to be used to collect a plurality of samples and introduce the plurality of samples into an analyzer,
the auto-sampler comprising:
a sample arranging member which is a member including a plurality of sample arrangement units for arrangement of a plurality of samples, and to which identification information is attached at a predetermined position, the identification information being configured to identify a batch file which is to be used for measuring one or the plurality of samples arranged in a corresponding some or all of the plurality of sample arrangement units.

14. An auto-sampler to be used to collect a plurality of samples and introduce the plurality of samples into an analyzer,
the auto-sampler comprising:
a sample arranging member which is a member including a plurality of sample arrangement units for arrangement of a plurality of samples, and to which sample information is attached at a predetermined position in correspondence to each of some or all of the plurality of sample arrangement units, the sample information being configured to identify each of the plurality of samples to be set in a corresponding one of the some or all of the plurality of sample arrangement units.
